(19) United States
(12) Patent Application Publication
(10) Pub. No.: US 2014/0019126 A1
(43) Pub. Date: Jan. 16, 2014

(54) SPEECH-TO-TEXT RECOGNITION OF NON-DICTIONARY WORDS USING LOCATION DATA

(71) Applicants: Zachary W. Abrams, Durham, NC (US); Paula Besterman, Cary, NC (US); Pamela S. Ross, Raleigh, NC (US); Eric Woods, Durham, NC (US)

(72) Inventors: Zachary W. Abrams, Durham, NC (US); Paula Besterman, Cary, NC (US); Pamela S. Ross, Raleigh, NC (US); Eric Woods, Durham, NC (US)

(73) Assignee: INTERNATIONAL BUSINESS MACHINES CORPORATION, Armonk, NY (US)

(21) Appl. No.: 13/548,351

(22) Filed: Jul. 13, 2012

(51) Int. Cl. G10L 15/26

(52) U.S. Cl. 704/235; 704/E15.043

(57) ABSTRACT

Speech-to-text recognition of non-dictionary words by an electronic device having a speech-to-text recognizer and a global positing system (GPS) includes receiving a user's speech and attempting to convert the speech to text using at least a word dictionary; in response to a portion of the speech being unrecognizable, determining if the speech contains a location-based phrase that contains a term relating to any combination of a geographic origin or destination, a current location, and a route; retrieving from a global positioning system location data that are within geographical proximity to the location-based phrase, wherein the location data include any combination of street names, business names, places of interest, and municipality names; updating the word dictionary by temporarily adding words from the location data to the word dictionary; and using the updated word dictionary to convert the previously unrecognized portion of the speech to text.

### BACKGROUND

Computer speech recognition systems operate to translate spoken words in the text, and are also known as speech-to-text or automatic speech recognition systems. Speech-to-text systems recognize words and phrases based on various algorithms, grammars, and one or more word dictionaries. Due to size limitations of memory in electronic devices, such as navigation systems, the word dictionary may not store all words known to a particular language, which can lead to errors and unrecognized words.

Accordingly, it would be desirable to provide an improved method and system for performing speech-to-text recognition of non-dictionary words.

### BRIEF SUMMARY

Exemplary embodiments provide methods and systems for performing speech-to-text recognition of non-dictionary words by an electronic device having a speech-to-text recognizer and a global positing system (GPS). Aspects of exemplary embodiment include receiving a user's speech and attempting to convert the speech to text using at least a word dictionary; in response to a portion of the speech being unrecognizable, determining if the speech contains a location-based phrase that contains a term relating to any combination of a geographic origin or destination, a current location, and a route; retrieving from a global positioning system location data that are within geographical proximity to the location-based phrase, wherein the location data include any combination of street names, business names, places of interest, and municipality names; updating the word dictionary by temporarily adding words from the location data to the word dictionary; and using the updated word dictionary to convert the previously unrecognized portion of the speech to text.

### BRIEF DESCRIPTION OF SEVERAL VIEWS OF THE DRAWINGS

FIG. 1 is a diagram illustrating one embodiment of a speech-to-text recognition system for improved translation of non-dictionary words using location data.

FIG. 2 is a flow diagram illustrating one embodiment of a process for performing speech-to-text recognition of non-dictionary words by an electronic device having a speech-to-text recognizer and a global positing system (GPS).

### DETAILED DESCRIPTION

The exemplary embodiment relates to improved speech-to-text recognition of non-dictionary words using location data. The following description is presented to enable one of ordinary skill in the art to make and use the invention and is provided in the context of a patent application and its requirements. Various modifications to the exemplary embodiments and the generic principles and features described herein will be readily apparent. The exemplary embodiments are mainly described in terms of particular methods and systems provided in particular implementations. However, the methods and systems will operate effectively in other implementations. Phrases such as “exemplary embodiment”, “one embodiment” and “another embodiment” may refer to the same or different embodiments. The embodiments will be described with respect to systems and/or devices having certain components. However, the systems and/or devices may include more or less components than those shown, and variations in the arrangement and type of the components may be made without departing from the scope of the invention. The exemplary embodiments will also be described in the context of particular methods having certain steps. However, the method and system operate effectively for other methods having different and/or additional steps and steps in different orders that are not inconsistent with the exemplary embodiments. Thus, the present invention is not intended to be limited to the embodiments shown, but is to be accorded the widest scope consistent with the principles and features described herein.

The exemplary embodiments provide improved speech-to-text recognition of non-dictionary words using location data. Software components interacting with a speech-to-text recognizer detect when a user utters a location-based phrase, and then retrieve from a global positioning system (GPS) words associated with places (streets, business, municipality names, etc.) that are within geographic proximity to the location-based phrase or within proximity to the user's route. A word dictionary used by the speech-to-text recognizer is dynamically updated with the retrieved words. The updated word dictionary is then used to recognize any of the user's spoken words that were previously unrecognizable, thereby increasing accuracy of the by the speech-to-text recognizer.

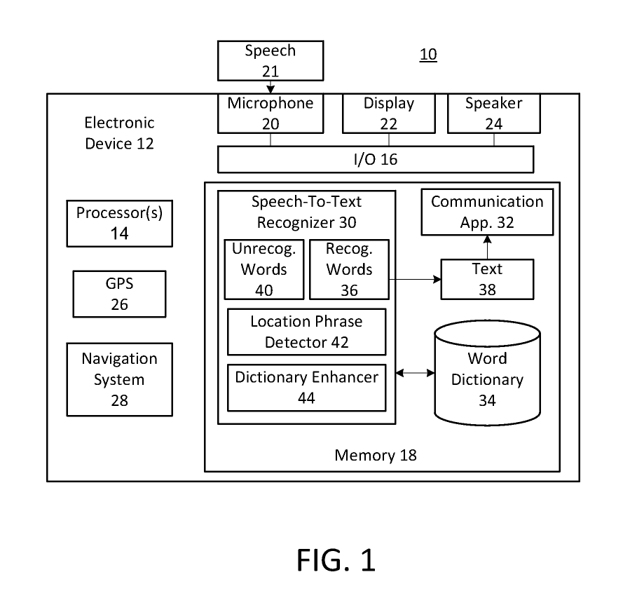

FIG. 1 is a diagram illustrating one embodiment of a speech-to-text recognition system for improved translation of non-dictionary words using location data. The speech-to-text system 10 is implemented as an electronic device 12 that may exist in various forms, including a vehicle navigation/entertainment system, a smartphone, tablet, or any other type of device or computer that is equipped with a global positioning system (GPS) 14. The electronic device 12 may include hardware components of typical computing devices, including at least one processor 14, input/output (I/O) devices 16 and memory 18. Examples of input-type I/O devices 16 may include a microphone 20 for input of a user's speech 21, a touch screen display 22, and the like. Examples of output-type I/O devices 16 may also include the display 22, a speaker 24, and the like). The I/O devices 16 can be coupled to the system either directly or through intervening I/O controllers (not shown).

The device 12 may also include a navigation system 28 that provides a user with turn-by-turn directions using the GPS 26. The navigation system 28 may be either hardware based, such as in an automobile, or software based, such as an application running on a smartphone, for example.

The processor(s) 14 may be part of a data processing system suitable for storing and/or executing program code. The processor 14 is coupled directly or indirectly to memory elements through a system bus (not shown). Memory 18 may include one or more types of computer-readable media such as local memory employed during actual execution of the program code, bulk storage, and cache memories which provide temporary storage of at least some program code in order to reduce the number of times code must be retrieved from bulk storage during execution.

The processor 14 executes various types of system and application programs, including a speech-to-text recognizer 30 and a communication application 32. The navigation system 28 may use the speech-to-text recognizer 30 to allow input via voice. The speech-to-text recognizer 30 receives a user's speech 21 through microphone 20 and converts the speech 21 into a stream of phonemes. The speech-to-text recognizer 30 recognizes words and phrases based on various algorithms, grammars, and one or more word dictionaries 34. Recognized words 36 are converted to text 38 and output to one or more applications including the navigation system 28 and/or a communication application 32. As used herein, the communication application 32 may be configured to process short messaging service (SMS), instant messaging (IM), e-mail, chats, blogs, or even word processing.

Due to size limitations of memory 18, the word dictionary 34 may not store all words known to a particular language, which can lead to recognition errors and unrecognized words 40. Words not included in the word dictionary 34 are hereby referred to as “non-dictionary words.” Examples of non-dictionary words may include local street and business names for instance.

According to the exemplary embodiment, a location phrase detector 42 and a dictionary enhancer 44 are provided to improve the accuracy of the speech-to-text recognizer 31 by dynamically adding words to the word dictionary 34 based on location data from the GPS 26. In one embodiment, in response to the location phrase detector 42 detecting that the user has spoken a location-based phrase, the dictionary enhancer 44 retrieves GPS data within geographic proximity to the location-based phrase uttered by the user or within proximity to a route the user is currently navigating via the navigation system 28. The dictionary enhancer 44 then adds words from the GPS data to the word dictionary 34. The enhanced word dictionary 34 is used by the speech-to-text recognizer 30 to recognize any of the use's spoken words that were previously unrecognizable, thereby increasing accuracy of the by the speech-to-text recognizer 30.

Although the location phrase detector 42 and the 44 are shown as components of the speech-to-text recognizer 30, the location phrase detector 42 and the dictionary enhancer 44 may be implemented as separate applications or as plug-ins to the speech-to-text recognizer 30. Also, the location phrase detector 42 and the dictionary enhancer 44 may be implemented as more or less than the number of components shown.

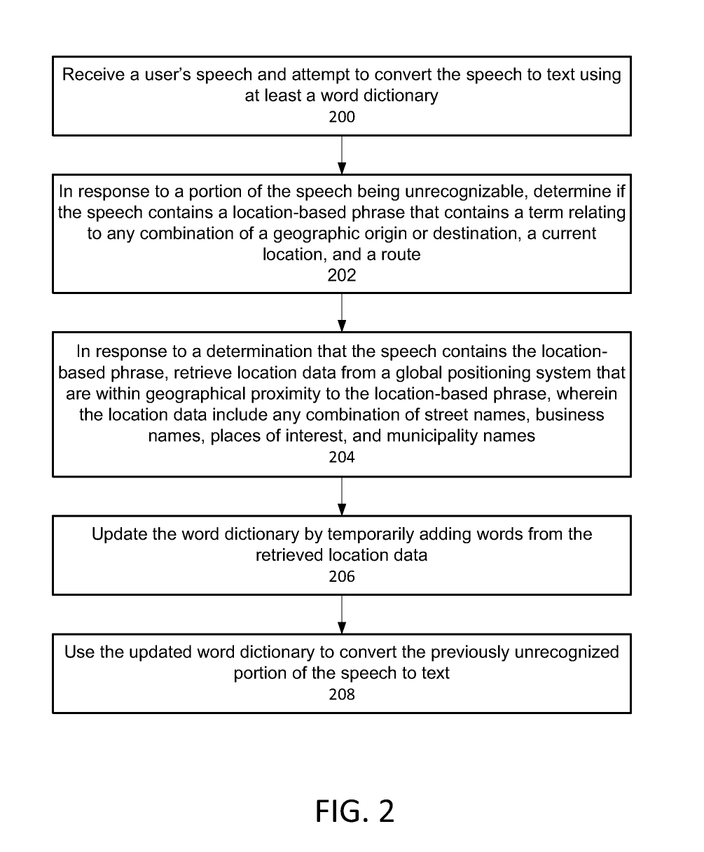

FIG. 2 is a flow diagram illustrating one embodiment of a process for performing speech-to-text recognition of non-dictionary words by an electronic device having a speech-to-text recognizer and a global positing system (GPS). The process may include receiving a user's speech and attempting to convert the speech to text using at least a word dictionary (block 200). As described above, the user's speech 21 is received by microphone 20 and input to speech-to-text recognizer 30 for conversion of the speech to text 38. The speech-to-text recognizer 30 utilizes word dictionary 34 to attempt to recognize the speech.

In one embodiment, the user speech may be received after the user activates a route guidance feature of the navigation system 28 and activates speech-to-text translation. Examples types of applications that may use the speech-to-text translation include the navigation system 28 for input of voice commands, and the communication application 32 for texting via voice.

As an example, consider the following scenario. The user is driving in a car in which the navigation system 28 (e.g., belonging to the car, a smartphone or a handheld navigation system) is routing user from her house to a restaurant where the user is meeting a friend. Assume further that the friend sends a text to the user asking the whereabouts of the user. The user may invoke a voice-to text feature on her phone, since texting while driving is illegal, and wants to tell her friend where she is or what she is near. The user says “I am next Neiman Marcus on Salisbury Street.” If the words “Neiman,” “Marcus,” or “Salisbury” are not in the word dictionary 34, then the speech-to-text process may result in unrecognized words 40.

In response to a portion of the speech being unrecognizable, it is determined if the speech contains a location-based phrase that contains a term relating to any combination of a geographic origin or destination, a current location, and a route (block 202). In one embodiment, once an unrecognized word is detected, the location phrase detector 42 is used to analyze the speech to detect the location-based phrase based on a set of grammar rules or heuristics that recognize geographic origin and destination phrases, current location phrases, and route phrases.

For example, the location-phrase detector 42 may be configured to recognize geographic origin and destination phrases in the speech 21, such as “I'm coming from”/“I'm leaving from/the”/“I'm on my way to”/“I'm heading towards”/I'm meeting [someone/person's name] at”, and the like. The location-phrase detector 42 may be further configured to recognize current location phrases when terms are detected in the speech 21, such as “I'm near”/“I'm right beside”/“I'm next two”/“passing by”/and the like. The location-phrase detector 22 may be further configured to recognize route phrases when terms are detected in the speech 21, such as “I'm traveling [direction] [on/along][highway or street name]”/“turning [right/left] on”/and the like.

In response to determining that the speech contains the location-based phrase, location data are retrieved from a global positioning system that are within geographical proximity to the location-based phrase, wherein the location data include any combination of street names, business names, places of interest, and municipality names (block 204).

In one embodiment, the dictionary enhancer 44 may retrieve the location data from the local GPS 26, the local navigation system 28, or a remote source over a wired or wireless connection, such as a cloud based navigation system. In one embodiment, the dictionary enhancer 44 may retrieve the location data from the GPS 26 by forming and sending a query to the GPS for based on the location-based phrase and a proximity or distance setting (e.g., within “x” miles). For example, if the user's location-based phrase is “I'm passing over the Golden Gate Bridge”, then the dictionary enhancer 44 may request all location with 5 miles of the Golden Gate Bridge.

In one embodiment, in response to determining that no location-based phrase is detected or that no geographic-based word can be recognized in the location-based phrase, then the dictionary enhancer 44 may retrieve all location data from the GPS 26 that is within proximity to the user's entire route. Alternatively, the dictionary enhancer 44 may retrieve all location data from the GPS 26 that is within proximity to the user's current location.

The word dictionary is then updated by temporarily adding words from the retrieved location data to the word dictionary (step 206).

In a further embodiment, the dictionary enhancer 44 may weight the words added to the word dictionary 34 based on the word's proximity to the user's geographic origin or destination, a current location, or route. That is, words closer in distance to the user's geographic origin or destination, current location, or route may be weighted higher than words farther away.

Based on either time or distance, the dictionary enhancer 44 may remove the words previously added to the word dictionary 34. For example, the dictionary enhancer 44 may remove the words belonging to places that are no longer in proximity to the user's geographic origin or destination, current location, or route. Alternatively, the dictionary enhancer 44 may remove words previously added to the word dictionary 34 after a predetermined period of time, e.g., ¼ hour to 1½ hours.

After the word dictionary 34 has been updated, the speech-to-text recognizer 30 uses the updated word dictionary to convert the previously unrecognized portion of the speech to text (block 208).

According to the exemplary embodiment, users origin/destination, current location and route information are used to effectively translate previously unrecognized words.

A method and system for performing speech-to-text recognition of non-dictionary words has been disclosed. As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

A computer readable storage medium may be, for example, but not limited to, an electronic, magnetic, optical, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any non-transitory medium that can contain, or store a program for use by or in connection with an instruction execution system, apparatus, or device.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The present invention has been described in accordance with the embodiments shown, and one of ordinary skill in the art will readily recognize that there could be variations to the embodiments, and any variations would be within the spirit and scope of the present invention. Accordingly, many modifications may be made by one of ordinary skill in the art without departing from the spirit and scope of the appended claims.

We claim:

1. A method for performing speech-to-text recognition of non-dictionary words by an electronic device having a speech-to-text recognizer and a global positing system (GPS), the method comprising:
receiving a user's speech and attempting to convert the speech to text using at least a word dictionary;
in response to a portion of the speech being unrecognizable, determining if the speech contains a location-based phrase that contains a term relating to any combination of a geographic origin or destination, a current location, and a route;
in response to determining that the speech contains the location-based phrase, retrieving from a global positioning system location data that are within geographical proximity to the location-based phrase, wherein the location data include any combination of street names, business names, places of interest, and municipality names;
updating the word dictionary by temporarily adding words from the location data to the word dictionary; and
using the updated word dictionary to convert the previously unrecognized portion of the speech to text.

2. The method of claim 1 further comprising receiving the user speech after the user activates a route guidance feature of a navigation system and then activates speech-to-text translation.

3. The method of claim 1 wherein determining if the speech contains a location-based phrase further comprises analyzing by, a location phrase detector, the speech to detect the location-based phrase based on a set of grammar rules that recognize geographic origin and destination phrases, current location phrases, and route phrases.

4. The method of claim 1 further comprising outputting the text to at least one of a navigation system and a communication application.

5. The method of claim 1 wherein retrieving location data that are within geographical proximity to the location-based phrase further comprises retrieving by a dictionary enhancer, the location data from at least one of a local global positioning system (GPS), a local navigation system, and a remote source over a wired or wireless connection.

6. The method of claim 1 further comprising in response to determining that no location-based phrase is detected or that no geographic-based word can be recognized in the location-based phrase, retrieving all location data that is within proximity to the user's entire route.

7. The method of claim 1 further comprising in response to determining that no location-based phrase is detected or that no geographic-based word can be recognized in the location-based phrase, retrieving all location data that is within proximity to the user's current location.

8. The method of claim 1 further comprising weighting the words added to the word dictionary based on the word's proximity to at least one of the user's geographic origin or destination, current location, and route.

9. The method of claim 1 further comprising removing the words added to the word dictionary based on at least one of:
removing the words that belong to places that are no longer in proximity to the user's geographic origin or destination, current location, or route, and
removing the words after a predetermined period of time.

10. A system, comprising:
a memory;
a global positing system (GPS);
a processor coupled to the memory; and
a software component executed by the processor that is configured to:
perform speech-to-text recognition of non-dictionary words by an electronic device;
receive a user's speech and attempting to convert the speech to text using at least a word dictionary;
in response to a portion of the speech being unrecognizable, determine if the speech contains a location-based phrase that contains a term relating to any combination of a geographic origin or destination, a current location, and a route;
in response to a determination that the speech contains the location-based phrase, retrieve from a global positioning system location data that are within geographical proximity to the location-based phrase, wherein the location data include any combination of street names, business names, places of interest, and municipality names;
update the word dictionary by temporarily adding words from the location data to the word dictionary; and
use the updated word dictionary to convert the previously unrecognized portion of the speech to text.

11. The system of claim 10 wherein the software component is further configured to receive the user speech after the user activates a route guidance feature of a navigation system and then activates speech-to-text translation.

12. The system of claim 10 wherein the determination that the speech contains a location-based phrase further comprises a location phrase detector that analyzes the speech to detect the location-based phrase based on a set of grammar rules that recognize geographic origin and destination phrases, current location phrases, and route phrases.

13. The system of claim 10 wherein the software component is further configured to output the text to at least one of a navigation system and a communication application.

14. The system of claim 10 wherein the retrieval of the location data that are within geographical proximity to the location-based phrase further comprises a dictionary enhancer retrieving the location data from at least one of a local global positioning system (GPS), a local navigation system, and a remote source over a wired or wireless connection.

15. The system of claim 10 wherein the software component is further configured to: in response to a determination that no location-based phrase is detected or that no geographic-based word can be recognized in the location-based phrase, retrieve all location data that is within proximity to the user's entire route.

16. The system of claim 10 wherein the software component is further configured to in response to a determination that no location-based phrase is detected or that no geographic-based word can be recognized in the location-based phrase, retrieve all location data that is within proximity to the user's current location.

17. The system of claim 10 wherein the software component is further configured to weight the words added to the word dictionary based on the word's proximity to at least one of the user's geographic origin or destination, current location, and route.

18. The system of claim 10 wherein the software component is further configured to remove the words added to the word dictionary based on at least one of:
removing the words that belong to places that are no longer in proximity to the user's geographic origin or destination, current location, or route, and
removing the words after a predetermined period of time.

19. A non-transitory computer-readable medium containing program instructions for performing speech-to-text recognition of non-dictionary words when executed in an electronic device having a speech-to-text recognizer and a global positing system (GPS), the program instructions for:
receiving a user's speech and attempting to convert the speech to text using at least a word dictionary;
in response to a portion of the speech being unrecognizable, determining if the speech contains a location-based phrase that contains a term relating to any combination of a geographic origin or destination, a current location, and a route;
in response to determining that the speech contains the location-based phrase, retrieving from a global positioning system location data that are within geographical proximity to the location-based phrase, wherein the location data include any combination of street names, business names, places of interest, and municipality names;
updating the word dictionary by temporarily adding words from the location data to the word dictionary; and
using the updated word dictionary to convert the previously unrecognized portion of the speech to text.

20. The computer-readable medium of claim 19 further comprising program instructions for receiving the user speech after the user activates a route guidance feature of a navigation system and then activates speech-to-text translation.

21. The computer-readable medium of claim 19 wherein determining if the speech contains a location-based phrase further comprises program instructions for analyzing by, a location phrase detector, the speech to detect the location-based phrase based on a set of grammar rules that recognize geographic origin and destination phrases, current location phrases, and route phrases.

22. The computer-readable medium of claim 19 further comprising program instructions for outputting the text to at least one of a navigation system and a communication application.

23. The computer-readable medium of claim 19 wherein retrieving location data that are within geographical proximity to the location-based phrase further comprises program instructions for retrieving by a dictionary enhancer, the location data from at least one of a local global positioning system (GPS), a local navigation system, and a remote source over a wired or wireless connection.

24. The computer-readable medium of claim 19 further comprising program instructions for in response to determining that no location-based phrase is detected or that no geographic-based word can be recognized in the location-based phrase, retrieving at least one of all location data that is within proximity to the user's entire route and retrieving all location data that is within proximity to the user's current location.

25. The computer-readable medium of claim 19 further comprising program instructions for weighting the words added to the word dictionary based on the word's proximity to at least one of the user's geographic origin or destination, current location, and route.
